(19) United States
(12) Patent Application Publication
(10) Pub. No.: US 2024/0232393 A1
(43) Pub. Date: Jul. 11, 2024

(54) PREDICTING ACCESS REVOCATION FOR APPLICATIONS USING MACHINE LEARNING MODELS

(71) Applicant: Capital One Services, LLC, McLean, VA (US)

(72) Inventors: Matthew Louis NOWAK, Midlothian, VA (US); Michael Anthony YOUNG, JR., Henrico, VA (US); Christopher McDANIEL, Glen Allen, VA (US)

(73) Assignee: Capital One Services, LLC, McLean, VA (US)

(21) Appl. No.: 18/152,143

(22) Filed: Jan. 9, 2023

(51) Int. Cl. G06F 21/60

(52) U.S. Cl. CPC G06F 21/604; G06F 2221/2113; G06F 2221/2141

(57) ABSTRACT

Methods and systems are described herein for predicting user access revocation for applications. The system may retrieve, based on user identifiers, user access information and user association information. The system may generate a dataset comprising entries for the user identifiers, where the entries include the user access information and the user association information. The system may input the dataset into a machine learning model to obtain predictions as to whether each user identifier requires access to one or more functions of one or more applications. In some embodiments, the machine learning model is trained to predict required user access. In response to determining that a particular prediction does not include one or more particular functions included in the user access information for a respective user identifier, the system may revoke access to the one or more particular functions from the user identifier.

### BACKGROUND

Application access requirements within an organization are often difficult to assess, as different individuals in different roles require varying access to applications. For example, different functions of a given application may be used by each member of the organization. Currently, systems rely on manual assessment of access requirements, which is difficult to determine accurately, especially when there are many users and many applications within an organization, and as a result, user access is often inaccurate. Too little access to application functions may hinder a user's ability to perform their duties while too much access is an opportunity for malfeasance. Thus, systems and methods are needed for accurately predicting user access requirements for applications.

### SUMMARY

Methods and systems are described herein for novel uses of artificial intelligence applications for predicting user access requirements for applications or features of those applications. Conventional systems are unable to predict access requirements, resulting in either a lack of necessary user access or unnecessary access for users, which is an opportunity for malfeasance. For example, it is difficult for conventional systems to predict access requirements and perform access revocation based on those requirements. Conventional systems may use group membership for assigning access to various applications and functions, but that may be an insufficient criteria. To overcome these technical deficiencies, methods and systems disclosed herein use a machine learning model to adjust user access based on group information and access information associated with users. Access adjustments may include removal of user access to various functions of applications or addition of user access to various functions of applications. This results in each user having the least amount of access that is required to perform their necessary functions. The system may train a machine learning model to predict required access to various functions of applications based on group information and access information associated with each user. For example, the group information may indicate other users with whom each user works, users with similar roles, teams on which each user works, or other information relating each user to other users within an organization. The access information may indicate functions of applications to which each user has access and functions that each user has historically accessed. The system may use the trained machine learning model to predict whether a user should have access to various functions of applications based on the group information and access information associated with that user. In response to predicting that a particular user should not have access to a certain function of an application—which the user can currently access—the system may revoke the user's access to that function.

In particular, the system may receive a training dataset including a first plurality of entries for a first plurality of users and a plurality of features. The plurality of features may include the group information and access information for each user. The group information may indicate other users and corresponding groups associated with each user. The access information may indicate one or more functions of one or more applications to which each user has access and the one or more functions which each user has accessed. In some embodiments, each entry may include an output label indicating whether each user requires access to the one or more functions of the one or more applications. For example, the training dataset may include users within an organization and may indicate each user's coworkers, teams, roles, and other users in similar roles. The training dataset may also include each user's current access permissions and access history. The output label for each entry may indicate whether a user requires access to various application functions based on their group and access information. The output labels may be determined manually, may be determined based on current permissions, or may be based on other criteria. The system may then use the training dataset to train a machine learning model to generate outputs that indicate whether a given user of a second plurality of users requires access to the one or more functions of the one or more applications.

The system may retrieve user group information and user access information for the second plurality of users based on a plurality of user identifiers associated with the second plurality of users. The user group information may indicate other user identifiers with which each user identifier is associated. The system may retrieve the user group information from a user listing indicating groups of users. The user access information may indicate the one or more functions of the one or more applications to which each user identifier has access and the one or more functions which each user identifier has accessed. Furthermore, the system may retrieve the user access information from a permissions database and an access log. For example, the user group information may indicate each user's coworkers, teams, roles, and other users in similar roles and the user access information may indicate each user's current access permissions and access history. The system may generate a dataset including a second plurality of entries comprising the user access information and the user group information for the plurality of user identifiers.

The system may then input the dataset into the machine learning model to obtain, from the machine learning model, a plurality of predictions as to whether each user identifier of the plurality of user identifiers requires access to the one or more functions of the one or more applications. For example, the machine learning model may output indications, probabilities, or predictions of whether each user requires access to various application functions based on their role, coworkers, teams, similar users, access permissions, access history, and any other relevant data. In some embodiments, the prediction may be binary (e.g., required access versus no required access), may be a probability of required access (e.g., zero to one hundred percent), or may be in some other form.

In some embodiments, the system may determine that one or more particular functions included in the access information are not included in the plurality of predictions. In other words, the machine learning model may predict that the user should not have access to a function that the user currently can access. For example, the prediction may be an indication that the access is not required, or the prediction may be a probability that does not meet a predetermined threshold for required access. In response, the system may revoke the user's access to the one or more particular functions. In some embodiments, the system may generate an alert indicating that the user has unnecessary access to the one or more functions and may transmit the alert to another user (e.g., a supervisor, manager, administrator, or other user).

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative system for predicting access revocation for applications using machine learning models, in accordance with one or more embodiments.

FIG. 2 illustrates a table that may store training data for training a machine learning model, in accordance with one or more embodiments.

FIG. 3 illustrates an exemplary machine learning model, in accordance with one or more embodiments.

FIG. 4 illustrates a data structure for input into a machine learning model, in accordance with one or more embodiments.

FIG. 5 illustrates a data structure representing access requirement predictions, in accordance with one or more embodiments.

FIG. 6 illustrates a computing device, in accordance with one or more embodiments.

FIG. 7 shows a flowchart of the process for predicting access revocation for applications using machine learning models, in accordance with one or more embodiments.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

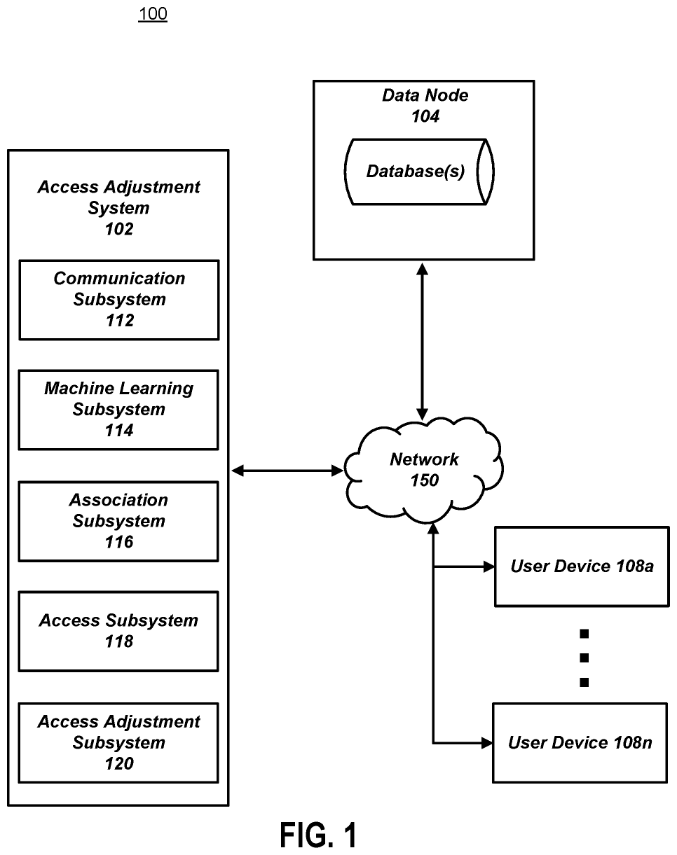

FIG. 1 shows an illustrative system 100 for predicting access revocation for applications using machine learning models, in accordance with one or more embodiments. System 100 may include access adjustment system 102, data node 104, and user devices 108a-108n. Access adjustment system 102 may include communication subsystem 112, machine learning subsystem 114, association subsystem 116, access subsystem 118, access adjustment subsystem 120, and other subsystems. In some embodiments, only one user device may be used while in other embodiments multiple user devices may be used. The user devices 108a-108n may be associated with one or more users. The user devices 108a-108n may be associated with one or more user accounts. In some embodiments, user devices 108a-108n may be computing devices that may receive and send data via network 150. User devices 108a-108n may be end-user computing devices (e.g., desktop computers, laptops, electronic tablets, smart phones, and/or other computing devices used by end users). User devices 108a-108n may output (e.g., via a graphical user interface) communications, recommendations, or other data received from, for example, communication subsystem 112.

Access adjustment system 102 may execute instructions for predicting access revocation for functions of applications. Access adjustment system 102 may include software, hardware, or a combination of the two. For example, communication subsystem 112 may include a network card (e.g., a wireless network card and/or a wired network card) that is associated with software to drive the card. In some embodiments, access adjustment system 102 may be a physical server or a virtual server that is running on a physical computer system. In some embodiments, access adjustment system 102 may be configured on a user device (e.g., a laptop computer, a smart phone, a desktop computer, an electronic tablet, or another suitable user device).

Data node 104 may store various data, including one or more machine learning models, training data, communications, and/or other suitable data. In some embodiments, data node 104 may also be used to train machine learning models. Data node 104 may include software, hardware, or a combination of the two. For example, data node 104 may be a physical server, or a virtual server that is running on a physical computer system. In some embodiments, access adjustment system 102 and data node 104 may reside on the same hardware and/or the same virtual server/computing device. Network 150 may be a local area network, a wide area network (e.g., the Internet), or a combination of the two.

Access adjustment system 102 (e.g., communication subsystem 112) may receive a training dataset. For example, communication subsystem 112 may receive the training dataset from data node 104. In some embodiments, the training dataset may be a data structure containing training data. The training dataset may include a first plurality of entries for a first plurality of users and a plurality of features. For example, the first plurality of entries may correspond to users who are already within an organization and who are used to train a machine learning model.

The plurality of features may indicate association (or group) information. The association information may indicate other users with whom each user is associated and groups with which each user is associated. For example, association information may indicate who else, within an organization, the user is associated with. The association information may include other users sharing a title with the user (e.g., “salesman”), other users in similar roles as the user, other users connected to the user in a hierarchy (e.g., supervisors and subordinates), other users with whom the user communicates frequently (e.g., based on emails, messages, meeting information, or other data), other users on the same teams or in the same groups as the user, and any other relevant information. In other words, the association information may capture each other user with whom a user is connected within the organization as well as how they are connected.

Some embodiments may apply various types of clustering analysis operations to the user information, such as DBCV operations, silhouette operations, Dunn Index, a Calinski-Harabasz Index, or another type of clustering validation method. Clustering analysis operations may include operations based on distances between clusters in a feature space of the clusters. A distance between a first cluster and a second cluster may include a distance between a position in a region defined by the first cluster and a position in a region defined by the second cluster. A region of a cluster may include the feature space positions of users of the cluster or other positions within an N-dimensional boundary defined by the cluster, where N is the number of dimensions of the feature space. For example, a distance between two clusters may include a distance between a first user of the first cluster and a second user of the second cluster in a feature space, a distance between the first user and a centroid of the second cluster, a distance between a centroid of the first cluster and a centroid of the second cluster, etc. Based on the clustering analysis, access adjustment system 102 may determine similarities and categories between different users within an organization. For example, access adjustment system 102 may determine, based on the clustering analysis, that two employees in different offices and on different teams have similar roles and should therefore be assigned similar access to applications.

The access information may indicate one or more functions of one or more applications to which each user has access and one or more functions which each user has accessed. For example, the access information may include each user's current access permissions and access history. The access information may relate to various functions of various applications used within an organization. For example, users may have access to applications to perform various work functions. Applications may include messaging applications, benefits applications, timekeeping applications, security applications, scheduling applications, or other applications used by an organization. Applications may operate physical objects, for example, by unlocking doors, turning on lights or appliances, operating machinery, or by performing other functions. The applications may each have various functions. For example, a scheduling application may have various functions such as scheduling meetings, changing meetings, cancelling meetings, sending meeting invitations, selecting meeting locations, changing scheduling permissions, and other functions.

Based on a user's role, the user may have access to certain functions within the application and may not have access to other functions. Applications may have different levels of access. For example, an application may include standard user access (e.g., with a lowest level of permissions), manager access (e.g., with more permissions), administrator access (e.g., with a highest level of permissions), or other levels. A user's current access permissions may include any application functions to which a user currently has access. A user's access history may include any application functions that a user has historically accessed (e.g., access dates, access frequency, etc.). Accessing applications or application functions may include logging into an application, opening an application, using an application function, or otherwise interacting with an application or application function.

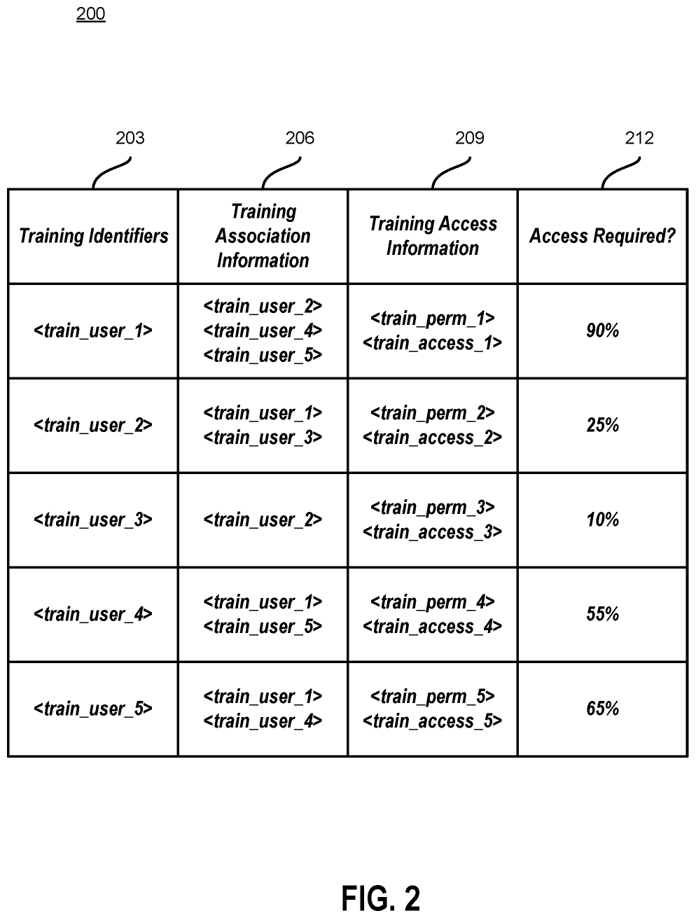

FIG. 2 illustrates a data structure 200 that may store training data for training a machine learning model, in accordance with one or more embodiments. For example, data structure 200 may represent a training dataset for a first plurality of users. Data structure 200 may include entries for a first plurality of users. Training identifiers 203 may correspond to the first plurality of users. Each entry may also include training association information 206 and training access information 209. For example, the training association information may include other users with whom each training identifier is associated. In some embodiments, the user identifiers included in training association information 206 may link to other data structures (e.g., data structures including association information and access information for a user associated with each training identifier included in training association information 206). In some embodiments, training access information 209 may include access permissions associated with each training identifier. For example, training access information 209 may include each application that a user associated with the training identifier is allowed to access. Training access information 209 may include each function of each application that a user associated with the training identifier is allowed to access. In some embodiments, training access information 209 may include historical access instances associated with each training identifier. For example, training access information 209 may include each instance of a user associated with each training identifier accessing an application or application function. In some embodiments, additional association or access information may be included in data structure 200. In some embodiments, data structure 200 may also include output labels 212 for each training identifier. For example, the output labels 212 may indicate whether a user associated with each training identifier requires access to applications or application functions. For example, output labels 212 may be binary (access required or no access required), probabilities (zero to 100 percent chance of required probability), or some other form of label. In some embodiments, each training identifier may be associated with multiple output labels, for example, each output label corresponding to an application used within the organization or each output label corresponding to an application function.

Returning to FIG. 1, communication subsystem 112 may receive the training data (e.g., data structure 200) from data node 104 or from another computing device. In some embodiments communication subsystem 112 may receive the training data from one or more user devices 108a-108n. Each user device may include a computing device enabling transmission of the data. However, in some embodiments, the user devices may connect wirelessly to access adjustment system 102. Communication subsystem 112 may pass the training data, or a pointer to the training data in memory, to machine learning subsystem 114.

Access adjustment system 102 (e.g., machine learning subsystem 114) may train a machine learning model using a training dataset such as data structure 200. For example, machine learning subsystem 114 may train a machine learning model to generate outputs that indicate whether a given user of a second plurality of users requires access to one or more functions of one or more applications. The machine learning model may therefore be trained using data from a first plurality of users to predict access requirements for a second plurality of users. In some embodiments, the machine learning model may update predictions over time based on changes in association or access information associated with users.

In some embodiments, machine learning subsystem 114 uses a natural language processing model that parses text strings (e.g., in permission files, access logs, user listings, etc.) describing user permissions, user access history, and user associations. The use of the natural language processing model allows the system to analyze numerous text strings describing the user permissions, occurrences of user access, relationships between users that may be found in numerous data files (e.g., permission files, access logs, user listings, etc.) created over time. Beyond simply matching text strings, the use of a natural language processing algorithm interprets the text strings for context, similarities, and connections. Based on the contexts and similarities, the natural language processing model may determine access or association information. This process may allow machine learning subsystem 114 to generate training data or machine learning model inputs based on text strings identified in data files throughout the system.

In some embodiments, machine learning subsystem 114 may categorize the text strings. For example, based on the identified contexts and similarities, the natural language processing model may create common descriptions or ontologies to describe disparities even across non-homogenous environments. These common descriptions or ontologies may allow machine learning subsystem 114 to refer to and cross-reference descriptions of user access and associations (e.g., in a centralized database) in a normalized manner. In some embodiments, categories may include categorization by application, by sector, by risk level, or according to other criteria. The natural language processing model may output the category information and machine learning subsystem 114 may include the category information with the training access information.

Machine learning subsystem 114 may include software components, hardware components, or a combination of both. For example, machine learning subsystem 114 may include software components (e.g., API calls) that access one or more machine learning models. Machine learning subsystem 114 may access training data, for example, in memory. In some embodiments, machine learning subsystem 114 may access the training data on data node 104 or on user devices 108a-108n. In some embodiments, the training data may include the access information, association information, and corresponding output labels for multiple users. In some embodiments, machine learning subsystem 114 may access one or more machine learning models. For example, machine learning subsystem 114 may access the machine learning models on data node 104 or on user devices 108a-108n. In some embodiments, the user machine learning models may be trained to predict user access requirements.

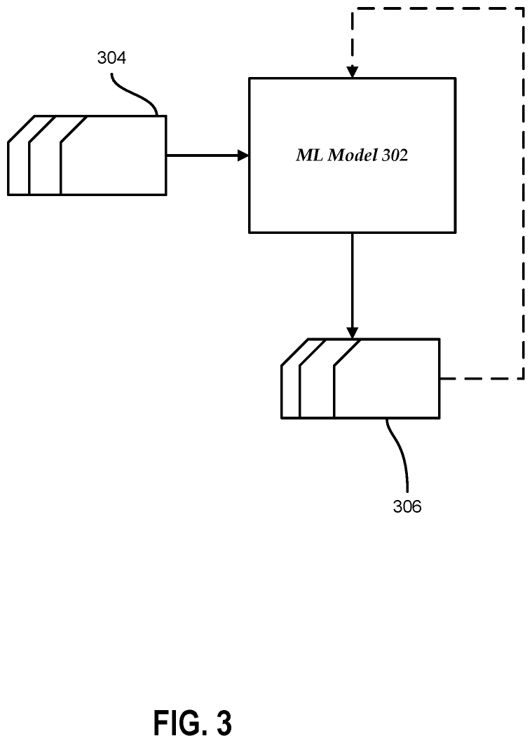

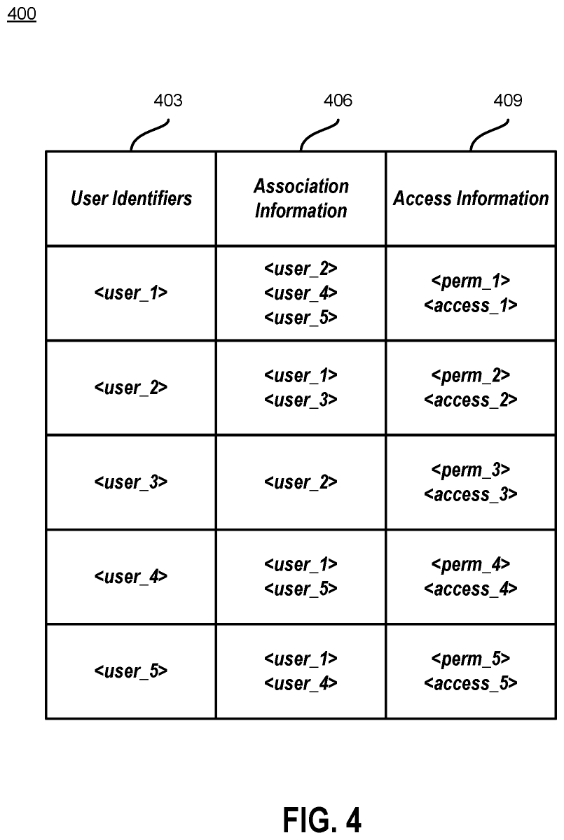

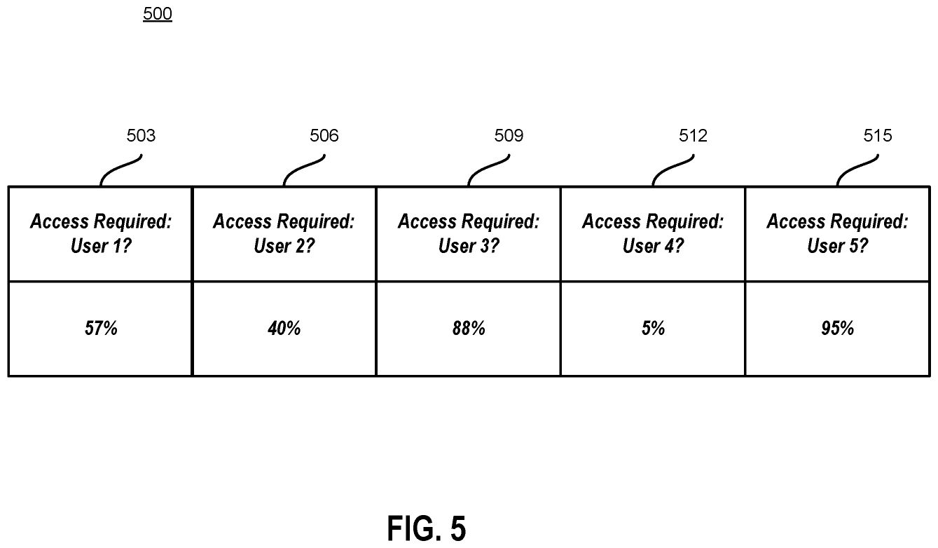

FIG. 3 illustrates an exemplary machine learning model 302, in accordance with one or more embodiments. The machine learning model may have been trained using association information, access information, and output labels (e.g., required access predictions) to predict whether users require application access. In some embodiments, machine learning model 302 may be included in machine learning subsystem 114 or may be associated with machine learning subsystem 114. Machine learning model 302 may take input 304 (e.g., association information and access information, as described in greater detail with respect to FIG. 4) and may generate outputs 306 (e.g., access requirement predictions, as described in greater detail with respect to FIG. 5). The output parameters may be fed back to the machine learning model as input to train the machine learning model (e.g., alone or in conjunction with user indications of the accuracy of outputs, labels associated with the inputs, or other reference feedback information). The machine learning model may update its configurations (e.g., weights, biases, or other parameters) based on the assessment of its prediction (e.g., of an information source) and reference feedback information (e.g., user indication of accuracy, reference labels, or other information). Connection weights may be adjusted, for example, if the machine learning model is a neural network, to reconcile differences between the neural network's prediction and the reference feedback. One or more neurons of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the machine learning model may be trained to generate better predictions of information sources that are responsive to a query.

In some embodiments, the machine learning model may include an artificial neural network. In such embodiments, the machine learning model may include an input layer and one or more hidden layers. Each neural unit of the machine learning model may be connected to one or more other neural units of the machine learning model. Such connections may be enforcing or inhibitory in their effect on the activation state of connected neural units. Each individual neural unit may have a summation function, which combines the values of all of its inputs together. Each connection (or the neural unit itself) may have a threshold function that a signal must surpass before it propagates to other neural units. The machine learning model may be self-learning and/or trained, rather than explicitly programmed, and may perform significantly better in certain areas of problem solving, as compared to computer programs that do not use machine learning. During training, an output layer of the machine learning model may correspond to a classification of machine learning model, and an input known to correspond to that classification may be input into an input layer of the machine learning model during training. During testing, an input without a known classification may be input into the input layer, and a determined classification may be output.

A machine learning model may include embedding layers in which each feature of a vector is converted into a dense vector representation. These dense vector representations for each feature may be pooled at one or more subsequent layers to convert the set of embedding vectors into a single vector.

The machine learning model may be structured as a factorization machine model. The machine learning model may be a non-linear model and/or a supervised learning model that can perform classification and/or regression. For example, the machine learning model may be a general-purpose supervised learning algorithm that the system uses for both classification and regression tasks. Alternatively, the machine learning model may include a Bayesian model configured to perform variational inference on the graph and/or vector.

Returning to FIG. 1, access adjustment system 102 may retrieve user association information and user access information for the second plurality of users. For example, association subsystem 116 may retrieve the user association information and access subsystem 118 may retrieve the user access information. In some embodiments, association subsystem 116 may retrieve the association information by accessing a user listing including user identifiers associated with the second plurality of users. For example, the user listing may be a database of employees within an organization and may include information about each user's role, title, teams, coworkers, and other relevant information. Association subsystem 116 may extract, from the user listing, a group identifier associated with each user identifier. The group identifier may indicate a group of user identifiers to which each user identifier belongs (e.g., salesmen, outreach group, fundraising team, etc.). Association subsystem 116 may identify the other user identifiers associated with the group identifier. For example, association subsystem 116 may identify the other salesmen, other members of the outreach group, other members of the fundraising team, and so on. In some embodiments, association subsystem 116 and access subsystem 118 may further retrieve association and access information for the other users identified as belonging to the same group as a particular user.

Access subsystem 118 may retrieve the user access information associated with each user of the second plurality of users. Access subsystem 118 may access a permissions database indicating the one or more functions of the one or more applications to which each user identifier has access. The permissions database may also indicate applications to which each user identifier has access, for example, if the user identifier is authorized to access the entire application. In some embodiments, the permissions database may include additional details, such as time restraints on the permissions (e.g., only allowed to access certain functions during a certain time frame or for a certain period of time), administrators in charge of each permission, actions allowed based on the permissions, or other details. Access subsystem 118 may additionally access an access log for the second plurality of users. The access log may indicate one or more occurrences of each user identifier accessing the one or more functions of the one or more applications to which the user identifier has access. For example, the access log may list each occurrence of access, along with dates, time stamps, details about the actions performed within each application, the permissions which allowed each occurrence of access, and any other information relevant to access history. Access subsystem 118 may extract, from the access log, the one or more occurrences of each user identifier accessing the one or more functions of the one or more applications.

Access adjustment system 102 may generate a dataset (e.g., such as data structure 400, as shown in FIG. 4) for a plurality of user identifiers corresponding to the second plurality of users. The dataset may include a second plurality of entries, corresponding to the second plurality of users, including the user access information and the user group information. Access adjustment system 102 may store the dataset in data node 104.

FIG. 4 illustrates a data structure 400 for input into a machine learning model, in accordance with one or more embodiments. Data structure 400 may include a number of user identifiers 403. User identifiers 403 may correspond to the second plurality of users. Each entry may also include association information 406 and access information 409. For example, the association information may include other users with whom each user identifier is associated. In some embodiments, the user identifiers included in association information 406 may link to other data structures (e.g., data structures including association information and access information for a user associated with each user identifier included in association information 406). In some embodiments, access information 409 may include access permissions associated with each user identifier. For example, access information 409 may include each application that a user associated with the user identifier is allowed to access. Access information 409 may include each function of each application that a user associated with the user identifier is allowed to access. In some embodiments, access information 409 may include historical access instances associated with each user identifier. For example, access information 409 may include each instance of a user associated with each user identifier accessing an application or application function. In some embodiments, additional association or access information may be included in data structure 400.

Returning to FIG. 1, machine learning subsystem 114 may input the dataset (e.g., data structure 400) into a machine learning model (e.g., machine learning model 302, as shown in FIG. 3). The machine learning model may be trained to predict required user access, as discussed above in relation to FIG. 3. In some embodiments, machine learning subsystem 114 may obtain a plurality of predictions as to whether each user identifier of the plurality of user identifiers requires access to the one or more functions of the one or more applications. In some embodiments, the predictions may be output as binary outputs (access required or no access required), probabilities (zero to 100 percent chance of required probability), predictions, or some other form of label.

FIG. 5 illustrates a data structure 500 representing access requirement predictions, in accordance with one or more embodiments. Data structure 500 may include a number of predictions indicating whether a number of users require access to a particular application or application function. Data structure 500 illustrates predictions that are output in the form of probabilities. As shown in FIG. 5, prediction 503 indicates a 57% probability that a first user requires access to a particular application or application function. Prediction 506 indicates a 40% probability that a first user requires access to a particular application or application function. Prediction 509 indicates an 88% probability that a first user requires access to a particular application or application function. Prediction 512 indicates a 5% probability that a first user requires access to a particular application or application function. Prediction 515 indicates a 95% probability that a first user requires access to a particular application or application function. In some embodiments, data structure 500 may be a subset of a larger data structure including predictions for a number of users and a number of applications or application functions.

In some embodiments, a prediction of 0% may indicate that a user certainly does not require access to a certain application or application function while a prediction of 100% may indicate that a user certainly does require access to a certain application or application function. Any prediction between zero and one hundred percent indicates some level of uncertainty. In some embodiments, access adjustment system 102 may retrieve or determine a threshold for the probabilities output by the machine learning model. For example, access adjustment system 102 may receive a threshold of 50%, such that any predictions below 50% (e.g., prediction 506 and prediction 512) are determined to mean that no access is required for the corresponding user while any predictions meeting or exceeding 50% (e.g., prediction 503, prediction 509, and prediction 515) are determined to mean that access is required for the corresponding user. The threshold may be higher, for example, if access adjustment system 102 is aimed at only allowing access when there is greater certainty that access is required. For example, access adjustment system 102 may require an employment-related purpose for accessing each function of each application and may therefore set a high threshold. The threshold may be lower, for example, if access adjustment system 102 is aimed at allowing access whenever there is any reasonable certainty that access is required.

Returning to FIG. 1, access adjustment system 102 (e.g., access adjustment subsystem 120) may take a number of actions based on the machine learning model predictions. For example, access adjustment subsystem 120 may compare the predictions to existing access permissions for each user. As an example, access adjustment subsystem 120 may compare a prediction of whether a user should have access to a particular prediction with the user's current access permissions (e.g., access information 409, as shown in FIG. 4). Access adjustment subsystem 120 may determine that the machine learning model prediction matches the user's current permissions (e.g., the user does not have access to a particular function and the machine learning model predicts that the user should not have access) and may therefore not take any actions with respect to that user and that particular function.

In some embodiments, access adjustment subsystem 120 may determine that the machine learning model prediction does not match the user's current permissions (e.g., the user has access to a particular function and the machine learning model predicts that the user does not require access to that particular function). For example, the prediction may be output as a percentage (e.g., as discussed above in relation to FIG. 5), and access adjustment subsystem 120 may determine that the probability does not reach a threshold for required access. In this example, access adjustment subsystem 120 may revoke the user's access to the particular function. Revoking access may include removing an indicator of the particular function from a user's permission file. Revoking access may include removing a user identifier associated with the user from a file of approved users associated with the particular function. Revoking access may include removing user login credentials associated with the user for the particular application. Revoking access may include revoking an access token associated with the particular function from the user identifier. In some embodiments, access adjustment subsystem 120 may revoke access in another manner.

In some embodiments, access adjustment subsystem 120 may, in response to determining that a user has access to a function that the machine learning model predicts the user does not require access to, output an alert. For example, access adjustment subsystem 120 may alert another user in the system (e.g., a supervisor, manager, administrator, etc.). The alert may include a user identifier associated with the user and the functions to which the user should not have access. In some embodiments, access adjustment subsystem 120 may allow a certain time period for a response to the alert (e.g., five minutes, one week, etc.) before revoking the access. During this time period, access adjustment system 102 (e.g., communication subsystem 112) may receive an instruction to override the access revocation. In some embodiments, if access adjustment system 102 determines that a user with unnecessary access poses a threat to the system, access adjustment subsystem 120 may initiate an alert response within the access adjustment system 102. For example, in response to determining that a user has unnecessary access, access adjustment system 102 may cause a network interruption.

In another example, access adjustment subsystem 120 may determine that the machine learning model prediction does not match the user's current permissions because the user does not have access to a particular function and the machine learning model predicts that the user requires access to that function. In this example, access adjustment subsystem 120 may add access to the particular function for the user. Adding access may include adding an indicator of the particular function to a user's permission file. Adding access may include adding a user identifier associated with the user to a file of approved users associated with the particular function. Adding access may include creating user login credentials for the user for the particular application. Adding access may include generating an access token associated with the particular function for the user identifier. In some embodiments, access adjustment subsystem 120 may add access in another manner. Access adjustment system 102 may thus add required access for new users (e.g., during onboarding) and existing users.

In some embodiments, in response to access adjustment subsystem 120 determining that a user has access that the machine learning model predicts is not required or that a user does not have access that the machine learning model predicts is required, communication subsystem 112 may generate a recommendation to revoke or add access for the user, respectively. For example, communication subsystem 112 may generate and output a recommendation to revoke or add access, and the recommendation may include the user and the particular functions for which access is to be revoked or added. In some embodiments, communication subsystem 112 may generate and output a recommendation to revoke or add access for the same function for other users associated with the user. For example, communication subsystem 112 may output a recommendation to take the same action (i.e., revoking or adding access) for other users associated with a group identifier of a group or team to which the user belongs. Thus, based on predictions generated for a first user, access adjustment system 102 may recommend actions to be taken for similar users that are currently in the system or are added to the system in the future.

### Computing Environment

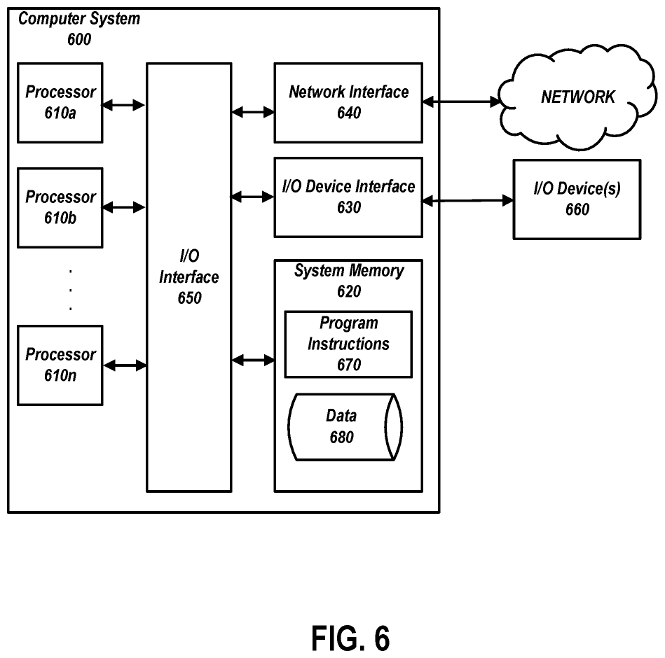

FIG. 6 shows an example computing system 600 that may be used in accordance with some embodiments of this disclosure. A person skilled in the art would understand that those terms may be used interchangeably. The components of FIG. 6 may be used to perform some or all operations discussed in relation to FIGS. 1-5. Furthermore, various portions of the systems and methods described herein may include or be executed on one or more computer systems similar to computing system 600. Further, processes and modules described herein may be executed by one or more processing systems similar to that of computing system 600.

Computing system 600 may include one or more processors (e.g., processors 610a-610n) coupled to system memory 620, an input/output (I/O) device interface 630, and a network interface 640 via an I/O interface 650. A processor may include a single processor, or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 600. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 620). Computing system 600 may be a uni-processor system including one processor (e.g., processor 610a), or a multi-processor system including any number of suitable processors (e.g., 610a-610n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, for example., an FPGA (field-programmable gate array) or an ASIC (application-specific integrated circuit). Computing system 600 may include a plurality of computing devices (e.g., distributed computer systems) to implement various processing functions.

I/O device interface 630 may provide an interface for connection of one or more I/O devices 660 to computing system 600. I/O devices may include devices that receive input (e.g., from a user) or output information (e.g., to a user). I/O devices 660 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 660 may be connected to computing system 600 through a wired or wireless connection. I/O devices 660 may be connected to computing system 600 from a remote location. I/O devices 660 located on remote computer systems, for example, may be connected to computing system 600 via a network and network interface 640.

Network interface 640 may include a network adapter that provides for connection of computing system 600 to a network. Network interface 640 may facilitate data exchange between computing system 600 and other devices connected to the network. Network interface 640 may support wired or wireless communication. The network may include an electronic communication network, such as the Internet, a local area network (LAN), a wide area network (WAN), a cellular communications network, or the like.

System memory 620 may be configured to store program instructions 670 or data 680. Program instructions 670 may be executable by a processor (e.g., one or more of processors 610a-610n) to implement one or more embodiments of the present techniques. Program instructions 670 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site or distributed across multiple remote sites and interconnected by a communication network.

System memory 620 may include a tangible program carrier having program instructions stored thereon. A tangible program carrier may include a non-transitory computer-readable storage medium. A non-transitory computer-readable storage medium may include a machine-readable storage device, a machine-readable storage substrate, a memory device, or any combination thereof. A non-transitory computer-readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard drives), or the like. System memory 620 may include a non-transitory computer-readable storage medium that may have program instructions stored thereon that are executable by a computer processor (e.g., one or more of processors 610a-610n) to cause the subject matter and the functional operations described herein. A memory (e.g., system memory 620) may include a single memory device and/or a plurality of memory devices (e.g., distributed memory devices).

I/O interface 650 may be configured to coordinate I/O traffic between processors 610a-610n, system memory 620, network interface 640, I/O devices 660, and/or other peripheral devices. I/O interface 650 may perform protocol, timing, or other data transformations to convert data signals from one component (e.g., system memory 620) into a format suitable for use by another component (e.g., processors 610a-610n). I/O interface 650 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 600, or multiple computer systems 600 configured to host different portions or instances of embodiments. Multiple computer systems 600 may provide for parallel or sequential processing/execution of one or more portions of the techniques described herein.

Those skilled in the art will appreciate that computing system 600 is merely illustrative, and is not intended to limit the scope of the techniques described herein. Computing system 600 may include any combination of devices or software that may perform or otherwise provide for the performance of the techniques described herein. For example, computing system 600 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a Global Positioning System (GPS), or the like. Computing system 600 may also be connected to other devices that are not illustrated, or may operate as a stand-alone system. In addition, the functionality provided by the illustrated components may, in some embodiments, be combined in fewer components, or distributed in additional components. Similarly, in some embodiments, the functionality of some of the illustrated components may not be provided, or other additional functionality may be available.

### Operation Flow

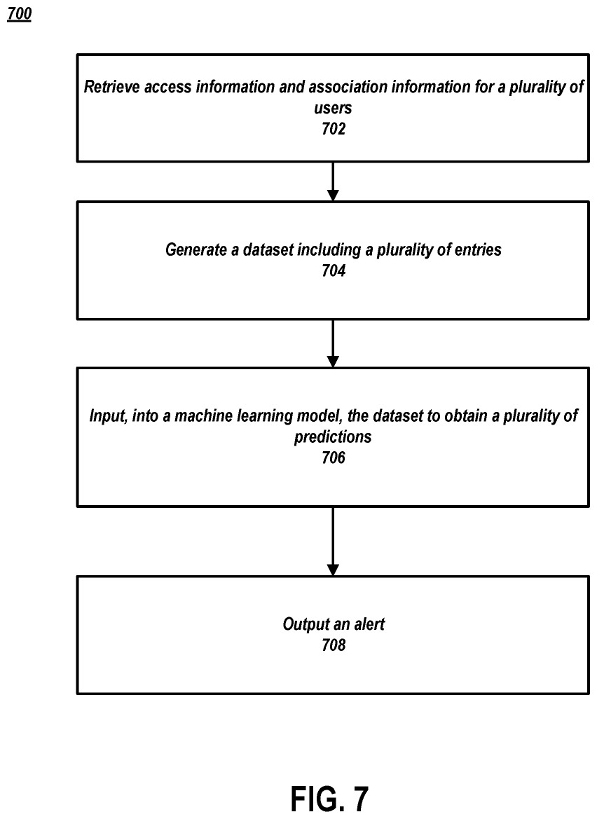

FIG. 7 shows a flowchart of the process 700 for predicting access revocation for applications using machine learning models, in accordance with one or more embodiments. For example, the system may use process 700 (e.g., as implemented on one or more system components described above) to predict access requirements for applications and application features for a plurality of users.

At step 702, process 700 (e.g., using one or more of processors 610a-610n) retrieves access information and association information for a plurality of users. For example, the access information may indicate one or more functions of one or more applications to which each user identifier has access (e.g., the user's permissions) and the one or more functions which each user identifier has accessed (e.g., the user's access log). The association information may indicate other user identifiers with which each user identifier is associated. In some embodiments, process 700 may retrieve the access and association information from I/O devices 660, from system memory 620, or elsewhere.

At step 704, process 700 (e.g., using one or more of processors 610a-610n) generates a dataset including a plurality of entries. The entries may correspond to a plurality of users. Each entry may include, for a plurality of user identifiers corresponding to the plurality of users, the access and association information relating to each user. In some embodiments, process 700 may store the dataset in system memory 620.

At step 706, process 700 (e.g., using one or more of processors 610a-610n) inputs, into a machine learning model, the dataset to obtain a plurality of predictions. In some embodiments, the machine learning model may be stored in system memory 620. Process 700 may obtain, from the machine learning model, a plurality of predictions as to whether each user identifier of the plurality of user identifiers requires access to the one or more functions of the one or more applications. The predictions may be binary (e.g., required access or no required access), probabilities of required access (e.g., zero to one hundred percent), predictions, or some other form.

At step 708, process 700 (e.g., using one or more of processors 610a-610n) outputs an alert. The alert may be generated in response to determining that a particular prediction does not include one or more particular functions included in the user access information corresponding to a respective user identifier. Process 700 may output the alert via I/O device interface 630, I/O devices 660, or network interface 640. The alert may include the user identifier and may indicate the one or more particular functions. In some embodiments, the alert may include a recommendation to revoke access from the user identifier.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 7.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method, the method comprising retrieving, based on a plurality of user identifiers, user access information and user association information for a plurality of users, generating a dataset comprising a plurality of entries for the plurality of user identifiers, the plurality of entries comprising the user access information and the user association information, inputting, into a machine learning model, the dataset to obtain a plurality of predictions as to whether each user identifier of the plurality of user identifiers requires access to one or more functions of one or more applications, wherein the machine learning model is trained to predict required user access, and in response to determining that a particular prediction does not include one or more particular functions included in the user access information corresponding to a respective user identifier, outputting an alert comprising the respective user identifier and the one or more particular functions of the one or more applications.

2. The method of any one of the preceding embodiments, wherein the user association information indicates other user identifiers with which each user identifier is associated and wherein the user access information indicates the one or more functions of the one or more applications to which each user identifier has access and the one or more functions which each training identifier has accessed.

3. The method of any one of the preceding embodiments, further in response to determining that the particular prediction does not include the one or more particular functions included in the user access information corresponding to a user identifier, revoking access to the one or more particular functions from the user identifier.

4. The method of any one of the preceding embodiments, further comprising receiving a training dataset comprising a plurality of training dataset entries for a plurality of identifiers, the plurality of entries comprising association information and access information, the association information indicating other identifiers with which each identifier is associated and the user access information indicating the one or more functions of the one or more applications to which each identifier has access and the one or more functions which each identifier has accessed, and wherein each training dataset entry comprises an output label indicating whether each identifier requires access to the one or more functions of the one or more applications, and training, using the training dataset, the machine learning model to generate outputs that indicate whether a given user of the plurality of users requires access to the one or more functions of the one or more applications.

5. The method of any one of the preceding embodiments, wherein the particular prediction comprises a probability of required access, and wherein determining that the particular prediction does not include the one or more particular functions included in the user access information comprises determining that the probability does not reach a threshold for required access.

6. The method of any one of the preceding embodiments, wherein retrieving the user access information for the plurality of users comprises accessing a permissions file indicating the one or more functions of the one or more applications to which each user identifier has access, accessing an access log for the plurality of users, wherein the access log indicates one or more occurrences of each user identifier accessing the one or more functions of the one or more applications to which each user identifier has access, and extracting, from the access log, the one or more occurrences of each user identifier accessing the one or more functions of the one or more applications.

7. The method of any one of the preceding embodiments, wherein retrieving the user association information for the plurality of users comprises accessing a user listing comprising the plurality of user identifiers, extracting, from the user listing, a group identifier associated with each user identifier, wherein the group identifier indicates a group of other user identifiers to which each user identifier belongs, and identifying the other user identifiers associated with the group identifier.

8. The method of any one of the preceding embodiments, further comprising generating a recommendation to revoke access to the one or more particular functions of the one or more applications from the other user identifiers associated with the group identifier, and outputting the recommendation.

9. A tangible, non-transitory, machine-readable medium storing instructions that, when executed by a data processing apparatus, cause the data processing apparatus to perform operations comprising those of any of embodiments 1-8.

10. A system comprising one or more processors; and memory storing instructions that, when executed by the processors, cause the processors to effectuate operations comprising those of any of embodiments 1-8.

11. A system comprising means for performing any of embodiments 1-8.

12. A system comprising cloud-based circuitry for performing any of embodiments 1-8.

What is claimed is:

1. A system for predicting access revocation for applications using machine learning models, the system comprising:
one or more processors; and
a non-transitory, computer-readable medium comprising instructions that when executed by the one or more processors cause operations comprising:
receiving a training dataset comprising a first plurality of entries for a first plurality of users and a plurality of features, wherein the plurality of features comprises group information for each user and access information for each user, the group information indicating other users and corresponding groups and the access information indicating one or more functions of one or more applications to which each user has access and the one or more functions which each user has accessed, and wherein each entry comprises an output label indicating whether each user requires access to the one or more functions of the one or more applications;
training, using the training dataset, a machine learning model to generate outputs that indicate whether a given user of a second plurality of users requires access to the one or more functions of the one or more applications;
retrieving, based on a plurality of user identifiers, user group information and user access information for the second plurality of users, the user group information indicating other user identifiers with which each user identifier is associated and the user access information indicating the one or more functions of the one or more applications to which each user identifier has access and the one or more functions which each user identifier has accessed;
generating a dataset comprising, for the plurality of user identifiers, a second plurality of entries comprising the user access information and the user group information;
inputting, into the machine learning model, the dataset to obtain a plurality of predictions as to whether each user identifier of the plurality of user identifiers requires access to the one or more functions of the one or more applications; and
in response to determining that a particular prediction does not include one or more particular functions included in the access information corresponding to a user identifier, revoking access to the one or more particular functions from the user identifier.

2. The system of claim 1, wherein the particular prediction comprises a probability of required access, and wherein the instructions for determining that the particular prediction does not include the one or more particular functions included in the access information further cause the one or more processors to determine that the probability does not reach a threshold for required access.

3. The system of claim 1, wherein the instructions for retrieving the access information for the second plurality of users cause the one or more processors to perform operations comprising:
accessing a permissions database indicating the one or more functions of the one or more applications to which each user identifier has access;
accessing an access log for the second plurality of users, wherein the access log indicates one or more occurrences of each user identifier accessing the one or more functions of the one or more applications to which the user identifier has access; and
extracting, from the access log, the one or more occurrences of each user identifier accessing the one or more functions of the one or more applications.

4. The system of claim 1, wherein retrieving the group information for the second plurality of users comprises:
accessing a user listing comprising the plurality of user identifiers;
extracting, from the user listing, a group identifier associated with each user identifier, wherein the group identifier indicates a group of user identifiers to which each user identifier belongs; and
identifying the other user identifiers associated with the group identifier.

5. A method comprising:
retrieving, based on a plurality of user identifiers, user access information and user association information for a plurality of users;
generating a dataset comprising a plurality of entries for the plurality of user identifiers, the plurality of entries comprising the user access information and the user association information;
inputting, into a machine learning model, the dataset to obtain a plurality of predictions as to whether each user identifier of the plurality of user identifiers requires access to one or more functions of one or more applications, wherein the machine learning model is trained to predict required user access; and
in response to determining that a particular prediction does not include one or more particular functions included in the user access information corresponding to a respective user identifier, outputting an alert comprising the respective user identifier and the one or more particular functions of the one or more applications.

6. The method of claim 5, wherein the user association information indicates other user identifiers with which each user identifier is associated and wherein the user access information indicates the one or more functions of the one or more applications to which each user identifier has access and the one or more functions which each training identifier has accessed.

7. The method of claim 5, further in response to determining that the particular prediction does not include the one or more particular functions included in the user access information corresponding to a user identifier, revoking access to the one or more particular functions from the user identifier.

8. The method of claim 5, further comprising:
receiving a training dataset comprising a plurality of training dataset entries for a plurality of identifiers, the plurality of entries comprising association information and access information, the association information indicating other identifiers with which each identifier is associated and the user access information indicating the one or more functions of the one or more applications to which each identifier has access and the one or more functions which each identifier has accessed, and wherein each training dataset entry comprises an output label indicating whether each identifier requires access to the one or more functions of the one or more applications; and
training, using the training dataset, the machine learning model to generate outputs that indicate whether a given user of the plurality of users requires access to the one or more functions of the one or more applications.

9. The method of claim 5, wherein the particular prediction comprises a probability of required access, and wherein determining that the particular prediction does not include the one or more particular functions included in the user access information comprises determining that the probability does not reach a threshold for required access.

10. The method of claim 5, wherein retrieving the user access information for the plurality of users comprises:
accessing a permissions file indicating the one or more functions of the one or more applications to which each user identifier has access;
accessing an access log for the plurality of users, wherein the access log indicates one or more occurrences of each user identifier accessing the one or more functions of the one or more applications to which each user identifier has access; and
extracting, from the access log, the one or more occurrences of each user identifier accessing the one or more functions of the one or more applications.

11. The method of claim 5, wherein retrieving the user association information for the plurality of users comprises:
accessing a user listing comprising the plurality of user identifiers;
extracting, from the user listing, a group identifier associated with each user identifier, wherein the group identifier indicates a group of other user identifiers to which each user identifier belongs; and
identifying the other user identifiers associated with the group identifier.

12. The method of claim 11, further comprising:
generating a recommendation to revoke access to the one or more particular functions of the one or more applications from the other user identifiers associated with the group identifier; and
outputting the recommendation.

13. A non-transitory, computer-readable medium storing instructions that when executed by one or more processors cause the one or more processors to perform operations comprising:
retrieving, based on a plurality of user identifiers, user access information and user association information for a plurality of users;
generating a dataset comprising a plurality of entries for the plurality of user identifiers, the plurality of entries comprising the user access information and the user association information;
inputting, into a machine learning model, the dataset to obtain a plurality of predictions as to whether each user identifier of the plurality of user identifiers requires access to one or more functions of one or more applications, wherein the machine learning model is trained to predict required user access; and
in response to determining that a particular prediction does not include one or more particular functions included in the user access information corresponding to a respective user identifier, outputting an alert comprising the respective user identifier and the one or more particular functions of the one or more applications.

14. The non-transitory, computer-readable medium of claim 13, wherein the user association information indicates other user identifiers with which each user identifier is associated and wherein the user access information indicates the one or more functions of the one or more applications to which each user identifier has access and the one or more functions which each training identifier has accessed.

15. The non-transitory, computer-readable medium of claim 13, wherein the instructions cause the one or more processors to perform operations further in response to determining that the particular prediction does not include the one or more particular functions included in the user access information corresponding to a user identifier, the operations comprising revoking access to the one or more particular functions from the user identifier.

16. The non-transitory, computer-readable medium of claim 13, wherein the instructions cause the one or more processors to perform operations comprising:
receiving a training dataset comprising a plurality of training dataset entries for a plurality of identifiers, the plurality of entries comprising association information and access information, the association information indicating other identifiers with which each identifier is associated and the user access information indicating the one or more functions of the one or more applications to which each identifier has access and the one or more functions which each identifier has accessed, and wherein each training dataset entry comprises an output label indicating whether each identifier requires access to the one or more functions of the one or more applications; and
training, using the training dataset, the machine learning model to generate outputs that indicate whether a given user of the plurality of users requires access to the one or more functions of the one or more applications.

17. The non-transitory, computer-readable medium of claim 13, wherein the particular prediction comprises a probability of required access, and wherein determining that the particular prediction does not include the one or more particular functions included in the user access information comprises determining that the probability does not breach a threshold for required access.

18. The non-transitory, computer-readable medium of claim 13, wherein the instructions for retrieving the user access information for the plurality of users cause the one or more processors to perform operations comprising:
accessing a permissions file indicating the one or more functions of the one or more applications to which each user identifier has access;
accessing an access log for the plurality of users, wherein the access log indicates one or more occurrences of each user identifier accessing the one or more functions of the one or more applications to which each user identifier has access; and
extracting, from the access log, the one or more occurrences of each user identifier accessing the one or more functions of the one or more applications.

19. The non-transitory, computer-readable medium of claim 13, wherein the instructions for retrieving the user association information for the plurality of users cause the one or more processors to perform operations comprising:
accessing a user listing comprising the plurality of user identifiers;
extracting, from the user listing, a group identifier associated with each user identifier, wherein the group identifier indicates a group of other user identifiers to which each user identifier belongs; and
identifying the other user identifiers associated with the group identifier.

20. The non-transitory, computer-readable medium of claim 19, wherein the instructions cause the one or more processors to perform operations comprising:
generating a recommendation to revoke access to the one or more particular functions of the one or more applications from the other user identifiers associated with the group identifier; and
outputting the recommendation.
